(19) United States
(12) Patent Application Publication
(10) Pub. No.: US 2003/0031621 A1
(43) Pub. Date: Feb. 13, 2003

(54) Process and apparatus for the generation of chlorine dioxide using a replenished foam system

(76) Inventors: Alan Gravitt, College Park, GA (US); John E. McDaniel, Douglasville, GA (US)

Correspondence Address: Alan C. Gravitt, 1698 Empire Avenue, East Point, GA, 30344, US

(21) Appl. No.: 10/155,177

(22) Filed: May 28, 2002

Related U.S. Application Data
(60) Provisional application No. 60/294,053, filed on May 29, 2001.

(51) Int. Cl. C01B 11/02

(52) U.S. Cl. 423/477; 423/478

(57) ABSTRACT

An aqueous solution of metal chlorate, mineral acid and a reducing agent are continuously or intermittently sprayed, in a pattern to achieve intimate mixing, into a spherical chamber creating an aqueous foam reaction mixture generating chlorine dioxide which is removed in a direction 90 degrees to the axis of the spray nozzles. A baffle plate may be used to reduce the open cross sectional area of the exit port to increase reaction efficiency. The reactants are a mineral acid and an alkali metal chlorate or chloric acid and a reducing agent such as hydrogen peroxide. The mineral acid is either diluted or concentrated sulfuric acid, hydrochloric acid, acetic acid, nitric acid or a blend thereof. The ratio of acid is greater than one and less than 3 kg acid per kg of ClO₂ formed. The chlorine dioxide may be removed with a stripper column.

### I. BACKGROUND

A. Field of the Invention

This invention relates to an improvement in the method and apparatus used for generating chlorine dioxide by the reduction of sodium chlorate with a reducing agent in a spherically shaped reactor wherein the reactants are sprayed to promote intimate contact and, thereby, promote efficient mixing.

Foam is generated in the reactor and is continually replenished as reactants are added, thus enhancing the intimate contact between the reactants contained in the thin films comprising the foam.

B. Discussion of Prior Art

U.S. Pat. No. 1,904,190, Becher, (Apr. 18, 1933) refers to the literature (Bray, “Zeitschrift fur physikalische Chemie” and Hofman, “Berichte”) as discussing a safe process for reacting sodium chlorate, concentrated sulfuric acid and a reducing agent to evolve chlorine dioxide. The patent discusses mixing the chlorate with “. . . inorganic substances indifferent to chlorates and sulphuric acid.” Thus, 67 years ago, a document teaches the generation of chlorine dioxide using sodium chlorate, concentrated sulfuric acid and a reducing agent, and identifies the problem of avoiding the explosive characteristics of chlorine dioxide.

In other patents, U.S. Pat. Nos. 2,036,311, White; 2,078,045, Vincent; 2,089,913, Cunningham; and 2,131,447, Logan, several methods addressing the problem of contaminating elemental chlorine are presented.

In U.S. Pat. No. 2,317,443, Cunningham, the excess of stoichiometric quantities of reactants, specifically the acid, are taught as a method of achieving “. . . as much as 90% to 95% or more of the available chlorine of the sodium chlorate as chlorine dioxide.”

In U.S. Pat. No. 2,280,938, Vincent (1942), we are taught a method for “. . . precisely proportioning the reacting substances in a manner and under the conditions which produce maximal yields of chlorine dioxide from chlorates.” The process is carried out in an aqueous medium and addresses the critical nature of the water present in the reaction. The presence of the chloride ion is noted as important, and the mixing of the chlorate and chloride reactants is shown to be advantageous. Again, excess acid is discussed as a requirement for maximizing the chlorate conversion.

In U.S. Pat. No. 2,332,181, Soule (1943), the next step in the development of the modem process is taken. Soule teaches a process wherein “. . . a metal chlorate is reacted with a mineral acid . . . and hydrogen peroxide.” He states that the hydrogen peroxide acts as an “. . . elective reducing agent to form chlorine dioxide without the formation of perchlorates and chlorine . . . ” with efficiencies “. . . close to 100%.” Soule also discusses an advantageous embodiment wherein he “. . . dissolves the metal chlorate in commercial 100% volume hydrogen peroxide with just sufficient addition of water to complete solution . . . ” and then introduces this mixture into a “. . . substantial excess of mineral acid.

In U.S. Pat. No. 2,344,346, Evans (1944), we are taught that “. . . in order to minimize the possibility of any undesired reactions between the chlorine dioxide and the reagents or other products of the reaction, the gaseous products are removed from the reaction as they are formed, and this may conveniently be done by suction.” He also teaches that the “. . . reaction vessel is advantageously of a cylindrical form.”

In U.S. Pat. No. 2,390,432, Evans (1945), we are essentially taught a plug flow reactor “. . . by contacting the solution of a chlorate and an acid reactant flowing in a stream during the reactions that result in the production of chlorine dioxide . . . and maintaining the reaction mixture at any position in the stream from contact and admixture with the reaction mixture at any other position . . . ”

In U.S. Pat. No. 2,654,656, Evans (1953), we are taught a concentration of sulfuric acid “. . . .not less than 70% . . . ” and that the “. . . action is very vigorous . . . ” and that the “. . . mixed liquids effervesce.” Also, we are told that the stripping of gases “. . . may in practice not be necessary, as a reasonable efficiency can be secured by omitting the stripping step.” This certainly anticipates the removal of gases and byproducts together.

In U.S. Pat. No. 2,736,636, Day et al. (1956), the refinement of ratios continues. “Accordingly, the present invention is directed to the production of chlorine dioxide by the use of increased amounts of reductant with simultaneous utilization of much less expensive quantities, with or without catalysts.”

In U.S. Pat. No. 2,833,624, Spauer (1958), we find that all of the refined elements of the recent technologies as to the material components or their equivalents are present. “It is the object of the invention to provide an improved method of producing chlorine dioxide involving the reaction of a chlorate, a strong acid and hydrogen peroxide. A particular object is to provide an improved and efficient method whereby the reaction is carried out rapidly, continuously and without undue hazard to produce dilute solutions of chlorine dioxide directly. Preferably the reacted mixture is continuously diluted immediately upon removal from the reaction zone . . . ” and “. . . it is usually most convenient to premix the peroxide, chlorate and chloride and feed the resulting single solution . . . while the strong acid is fed separately.”

In U.S. Pat. No. 2,936,219, Rapson (1960), we are taught, in example 1, that “. . . a chlorine dioxide generator consisting of a cylindrical glass vessel . . . ” is the subject of the patent.

A “single vessel” process is disclosed in U.S. Pat. No. 3,563,702, Partridge (1971).

An ammonium salt as a catalyst is disclosed in U.S. Pat. No. 3,764,663, Sims et al. (1973). Note that another listed catalyst, urea, decomposes at elevated temperatures yielding ammonia, providing the same ion in solution. The patent also lists fluosilicic acid as a catalyst. Fluosilicic acid is used in fluoridation of drinking water.

In U.S. Pat. No. 4,250,144, Ratigan teaches the use of an ejector or eductor to withdraw chlorine dioxide from the reactor.

Thus, much of the chemistry involved in the generation of chlorine dioxide is longstanding and well understood; however, recent environmental demands have heightened the need for a simple, safe, controllable, and efficient apparatus in which to generate chlorine dioxide.

Chlorine dioxide is primarily used in pulp bleaching, but there is a growing interest in using it also in other applications such as water purification, fat bleaching or removal of phenol from industrial wastes. Since chlorine dioxide is not stable and safe when in its gaseous form, it must be produced on-site.

Production of chlorine dioxide on a large scale is usually performed by reacting alkali metal chlorate or chloric acid with a reducing agent such as chloride ions, methanol or hydrogen peroxide at sub-atmospheric pressure, as described, for example, in EP patent 445493, U.S. Pat. No. 5,091,166, and U.S. Pat. No. 5,091,167. These production methods are highly efficient but are only suitable for production on a large scale, for example, at pulp mills consuming considerable amounts of chlorine dioxide for bleaching. In small-scale applications such as water purification, chlorine dioxide has generally been produced by reacting sodium chlorite with an acid.

EP patent 612,686 discloses production of chlorine dioxide from alkali metal chlorate and hydrogen peroxide at substantially atmospheric pressure.

U.S. Pat. No. 5,376,350 discloses a method of producing chlorine dioxide from chlorate ions and a reducing agent in a plug flow reactor, which is suitable for production in small scale. Although the method works well, it is still desirable to further improve the efficiency, simplicity and safety.

U.S. Pat. No. 5,895,638 discloses a method to provide an improved process suitable for small-scale production of chlorine dioxide from metal chlorate or chloric acid and a reducing agent. Particularly, it has as an objective, to provide a process involving a high production rate of chlorine dioxide and low consumption of chemicals in a reactor with low space requirements. These objectives are achieved in a process of producing chlorine dioxide by the reduction of chlorate ions with hydrogen peroxide as a reducing agent in a tubular reactor, preferably in the presence of a mineral acid, most preferably sulfuric acid, wherein the preferable degree of chlorate conversion in the reactor is above about 75%, preferably from about 80 to 100%, most preferably from about 95 to 100%.

### II. BRIEF DESCRIPTION OF THE INVENTION

In accordance with the present invention, chlorine dioxide is formed in a rapid, controllable, simple, safe and highly efficient manner using a novel apparatus. Hydrogen peroxide, in the presence of a mineral acid is used to reduce alkali metal chlorate in a spherically shaped reaction zone wherein the reactants are atomized, or sprayed, to promote intimate mixing. Foam is generated within the reactor and the reactants are replenished on the thin walls of the foam at regular intervals, or continuously, and, thereby, promote intimate contact of the reaction chemicals resulting in high conversion efficiencies of the chlorate over a broad production range. The apparatus also permits the use of the more commonly available 93% sulfuric acid without pre-cooling of the acid to compensate for the heat of dilution of the sulfuric acid. Removal of the reaction products from the reaction zone can be accomplished by using a vacuum generated by a water flow eductor, or other means, wherein the chlorine dioxide is immediately placed in an aqueous solution. The chlorine dioxide may also be removed from the reaction zone by means of air stripping, a fan, or pump driven vacuum generation whereby the chlorine dioxide is then stripped for use as a pure gas using a packed column or other apparatus.

In the preferred embodiment, the reaction occurs in a spherically shaped reaction zone and the resulting foam mixture of reaction by-products and chlorine dioxide is transported, in an undiluted state, through a production smoothing transport pipe with no accumulation or pooling of liquid to the liquid/gas intake port of a water flow eductor or other vacuum generating device. The reactants are injected into the reaction zone by means of atomizing nozzles, or spray nozzles, or injection ports which promote intimate mixing of the precursor feed streams. The production smoothing transport pipe may have an L/D ratio of 1/1 to greater than 24/1 in that the entire reaction is effectively confined to the spherically shaped reactor.

It has been shown that chlorine dioxide production rates may be increased, without increased pump pressure, in a reactor of given size by increasing the number of spray nozzles. The limit on safe production rates appears to depend simply on the amount of vacuum available or the ability to remove the chlorine dioxide in a rapid manner by other means such as stripping.

The effect of this novel process is to broaden the high chlorate conversion efficiency band within which the efficiency is 95% or greater by a factor of increase of 10 to 20 fold over that demonstrated by other reactors disclosed in the prior art. Previous reactor designs allowing the pooling of reactants produce a decrease in chlorate conversion efficiency with increased production rates while, concomitantly, requiring an increase in acid consumption to maintain maximum conversion efficiency of the chlorate.

A significant additional advantage of the invention is the ability to utilize commercially available 93% sulfuric acid in actual operation. The reactor design behaves in a novel manner in that previous designs, relying on either a plug flow reactor, or a pool of either acid or chlorate/peroxide blend, are unable to operate without significant problems with decomposition of the chlorine dioxide within the reactor most likely due to the high temperatures seen as a result of the high heats of dilution. The present invention, as illustrated in the examples that follow, allows the use of 93% sulfuric acid in ratios far below that either claimed, or in practice achieved, by other methods. The advantages are obvious. Less un-reacted acid is placed in the effluent stream. Less total acid is used, lowering the cost of operation, and the acid used is less expensive and more readily available than special dilution grades.

### III. BRIEF DESCRIPTION OF THE DRAWINGS

Aspects of the invention in its various embodiments are illustrated in the following drawings. The elements of the drawings are not necessarily drawn to scale, emphasis instead being placed on clearly illustrating the principles of the invention.

FIG. 1 illustrates the first embodiment of the invention, that of a reactor system that permits the ClO₂ and all by-products to be removed from the reaction area by eduction.

FIG. 2 illustrates the second embodiment of the invention wherein the foam containing the reaction products and ClO₂ are passed through a stripper column (12), to allow the removal and use of high purity ClO₂.

### DETAILED DESCRIPTION OF THE INVENTION

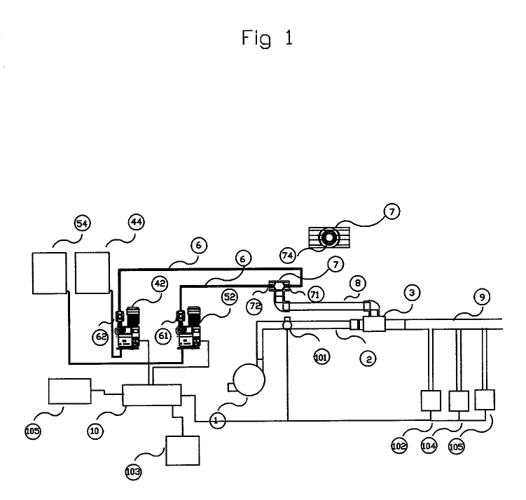

In FIG. 1, the system consists of the following components and subsystems: the Motive Water Source (1) which may be a pump or other pressure system, Eductor Piping (2) to connect the Motive Water Source (1) to the Eductor (3), the chlorate/reducing agent blend metered feed system, comprised either of an educted feed system, a Chlorate/Reducing Agent Blend Pump (42) or a chlorate/reducing agent blend gravity feed system, and a Chlorate/Reducing Agent Blend Storage Tank (44), an acid metered feed system comprised either of an acid educted feed system, an Acid Pump (52) or an acid gravity feed system and an Acid Storage Tank (54), Chemical Feed Piping (6) to connect the respective feed systems to the System Reactor (7), Acid Flow Check valve (61), Chlorate/reducing Agent Blend Flow Check Valve (62), Eductor/Reactor Connection Piping (8), and Effluent Out Feed Piping (9), a control system comprised of a System Controller (10), connected to input and output devices needed to control the system operation including a Flow Monitor for motive water (101), a Chlorine Dioxide Analyzer (102), Interface to a Digital Control System (103), pH Meter (104), ORP Meter (105), and a User Interface (105).

The System Reactor (7) is further comprised of the following: a Chlorate/Reducing Agent Blend Spray Nozzle (71), an Acid Spray Nozzle (72), a Spherical Reaction Chamber (73), and a Baffle (74).

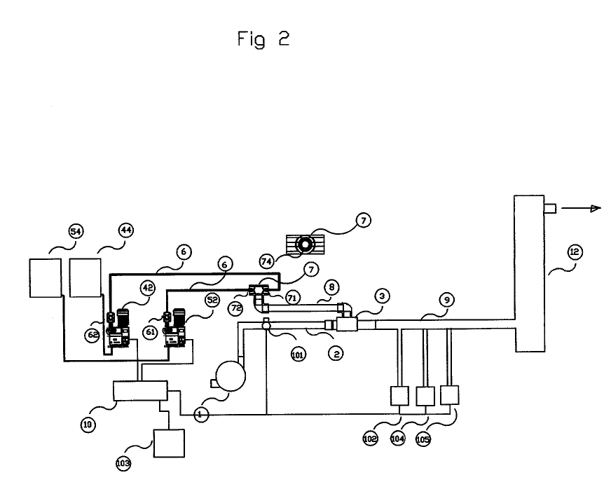

FIG. 2 contains the addition of a Stripper Column (12) that allows the removal of ClO₂ from the mixture of reaction products.

Operation of One Embodiment of the Invention.

Acid is metered from the Acid Storage Tank (54) by the Acid Pump (52) through the Acid Check Valve (61) and through the Acid Spray Nozzle (72) into the Spherical Reaction Chamber (73). Chlorate/reducing agent blend is similarly metered from the Chlorate/Reducing Agent Blend Storage Tank (44) by the Chlorate/Reducing Agent Blend Pump (42) through the Chlorate/Reducing Agent Blend Check Valve (62) through the Chlorate/Reducing Agent Blend Spray Nozzle (71) into the Spherical Reaction Chamber (73). The Acid Spray Nozzle (72) and the Chlorate/Reducing Agent Blend Spray Nozzle (71) are arranged to provide a broad area of intersection of the generally conical spray patterns generated by the Acid Spray Nozzle (72) and the Chlorate/Reducing Agent Blend Spray Nozzle (71). The resulting reaction initially produces a foam within the Spherical Reaction Chamber (73). This foam is partially retained in its foam state within the Spherical Reaction Chamber (73) by the Baffle (74). Successive amounts of the Acid and Chlorate/Reducing agent blend reactants are sprayed so that the residual foam is the target of and are replenished with reactants by the acid and Chlorate/reducing agent blend feed systems. The Eductor (3), by means of the motive water flow produced by the Motive Water Source (1), produces a vacuum upon the Eductor/Reactor Connection Piping (8), and thus on the System Reactor (7), removing the reaction products from the Spherical Reaction Chamber (73) continuously and transporting the reaction products into the motive water stream where they are mixed with the water stream and are ready for use in the variety of applications where ClO₂ is required.

The System Controller (10) receives information input via the User Interface (105) and/or the Flow Monitor for motive water (101), the Chlorine Dioxide Analyzer (102), Interface to a Digital Control System (103), pH Meter (104), ORP Meter (105). The System Controller (10) will respond with the appropriate production rate, or shutdown, or alert as appropriate to the current demand or conditions.

A control system comprised of a System Controller (10), connected to input and output devices needed to control the system operation including a Flow Monitor for motive water (101), a Chlorine dioxide Analyzer (102), Interface to a Digital Control System (103), pH Meter (104), ORP Meter (105).

### EXAMPLE 1

A process was performed according to the invention by continuously feeding a spherical reactor having an internal diameter of approximately one inch with 42 ml/min of an aqueous solution comprised of 34-wt. % sodium chloride, 0.6-wt. % sodium chloride, 11.3-wt. % hydrogen peroxide and 17 ml/min. of 93-wt % sulfuric acid. The reactor was operated at an pressure of 500 mm Hg and an external surface temperature of 135 degrees Fahrenheit. The resulting chlorine dioxide solution contained 322-PPM ClO₂ and demonstrated a chlorate conversion efficiency of 96.6%. The acid feed per kilogram of ClO₂ produced was 2.44 kilograms.

### EXAMPLE 2

A process was performed according to the invention by continuously feeding a spherical reactor having an internal diameter of approximately one inch with 37 ml/min of an aqueous solution comprised of 34-wt. % sodium chloride, 0.6-wt. % sodium chloride, 11.3-wt. % hydrogen peroxide and 17 ml/min. of 93-wt % sulfuric acid. The reactor was operated at a pressure of 500 mm Hg and an external surface temperature of 135 degrees Fahrenheit. The resulting chlorine dioxide solution contained 310-PPM ClO₂ and demonstrated a chlorate conversion efficiency of 100%. The acid feed per kilogram of ClO2 produced was 2.54 kilograms.

### EXAMPLE 3

A process was performed according to the invention by continuously feeding a spherical reactor having an internal diameter of approximately one inch with 31 ml/min of an aqueous solution comprised of 34-wt. % sodium chloride, 0.6-wt. % sodium chloride, 11.3-wt. % hydrogen peroxide and 17 ml/min. of 93-wt % sulfuric acid. The reactor was operated at a pressure of 500 mm Hg and an external surface temperature of 135 degrees Fahrenheit. The resulting chlorine dioxide solution contained 264-PPM ClO₂ and demonstrated a chlorate conversion efficiency of 100%. The acid feed per kilogram of ClO₂ produced was 2.98 kilograms.

That which is claimed:

1. A method for combining reactants for the production of chlorine dioxide where the reactants are injected by spraying into a spherical reaction chamber, being required to counter flow generally against the spray directions for removal from the chamber, where the reactants are used in such proportions and concentrations that a aqueous foam is formed by the first reaction and wherein the reactants are replenished by spraying the subsequent reactant additions onto the aqueous foam resulting in a highly efficient reaction taking place within the liquid film matrix forming the aqueous foam.

2. A method according to claim 1 where the reactant spray nozzles are oriented so as to direct a 45 to 160 degree conical spray pattern toward each other along a common axis, and where the reaction products are removed in a direction 90 degrees to that axis.

3. A method according to claim 1 where the reactant spray nozzles are oriented so as to direct a 75 to 120 degree conical spray pattern above an axis joining the nozzle orifices, wherein the axis defined by the center of the conical spray pattern lies at an angle between 2 and 85 degrees above the axis joining the spray orifices and where the reaction products are removed in a direction 90 degrees to that axis joining those orifices.

4. A method according to claim 1 where the exit port of the reactor is partially obstructed with a baffle plate that reduce the open cross sectional area to retain the foam reaction surface.

5. A method according to claim 4 wherein the baffle reduces the cross sectional area by 25% to 75%.

6. A method according to claim 4 wherein the baffle sufficiently reduces the cross sectional area so as to produce a retained foam medium to receive the subsequent reactant sprays.

7. A method according to claim 1 wherein the reactants are a mineral acid and a blend including either an alkali metal chlorate or chloric acid, and includes one or more reducing agents, and stabilizers contained within the commercially available hydrogen peroxide.

8. A method according to claim 1 where the mineral acid is either comprised totally of, or is a blend containing at least one of the following, sulfuric acid, Hydrochloric acid, Acetic acid, or Nitric acid, the metal chlorate is Sodium Chlorate, the reducing agent blend is at least one of the following, Hydrogen Peroxide, Sodium Chloride or Methanol, and the stabilizers are combinations of stannate compounds and phosphonic acids or their associated compounds in amounts that serve only to stabilize the reducing agents against decomposition.

9. A method according to claim one where the mineral acid is sulfuric acid and the concentration of the acid is a 93% commercial grade and where efficiencies are in excess of 95% conversion of the chlorate to Chlorine dioxide, and where the ratio of acid required to make chlorine dioxide is greater than 1 and less than 3 kg acid per kg of Chlorine dioxide formed.

10. A method according to claim 1 where the reaction products are passed into a stripper column wherein the chlorine dioxide is removed and made available for use in a gas form or in aqueous solution with less than 5% of other reaction products or reagents present, excluding water, water vapor or oxygen.
